(19) United States
(12) Patent Application Publication
(10) Pub. No.: US 2022/0131446 A1
(43) Pub. Date: Apr. 28, 2022

(54) Electrical Sheet for an Electrical Machine and Method for Producing an Electrical Sheet

(71) Applicant: Siemens Aktiengesellschaft, München (DE)

(72) Inventors: Carsten Schuh, Baldham (DE); Rolf Vollmer, Gersfeld (DE)

(73) Assignee: Siemens Aktiengesellschaft, München (DE)

(21) Appl. No.: 17/436,226

(22) PCT Filed: Mar. 4, 2019
(86) PCT No.: PCT/EP2019/055297

§ 371 Date: Sep. 3, 2021

(51) Int. Cl. H02K 9/197; H02K 1/16; H02K 1/20; H02K 9/20

(52) U.S. Cl. CPC H02K 9/197; H02K 9/20; H02K 1/20; H02K 1/16

(57) ABSTRACT

Various embodiments of the teachings herein include an electrical sheet for an electric machine, the electrical sheet comprises: two plates of a ferromagnetic material, the two plates arranged parallel to one another at a distance from one another forming an interior between the two; and a fluid in the interior. The two plates are connected to one another at respective edges circumferentially in a fluid-tight manner.

### CROSS-REFERENCE TO RELATED APPLICATIONS

This application is a U.S. National Stage Application of International Application No. PCT/EP2019/055297 filed Mar. 4, 2019, the contents of which are hereby incorporated by reference in their entirety.

### TECHNICAL FIELD

The present disclosure relates to electric machines. Various embodiments of the teachings herein include electrical sheets for an electric machine and/or methods for producing such an electrical sheet.

### BACKGROUND

During the operation of an electric machine, heat arises in windings of the electric machine in the electromagnets in the case of a motor or generator. The heat is given off in known electric machines to a cooling element for example. In various electric machines, for example motors or generators, the windings can be in contact with a machine component of the electric machine that is manufactured from electrical sheet, for example a stator or a rotor of the machine. Because of the required magnetic properties of such machine components, said components are frequently made of a material, in particular a ferromagnetic material, with a relatively low thermal conductivity. Therefore, the transporting away of the heat arising from the windings can be restricted, a corresponding cooling of the electric machine accordingly limited in its efficiency.

### SUMMARY

The teachings of the present disclosure include electrical sheets for an electric machine which provide improved transport of heat from a heat source of the electric machine to a heat sink of the electric machine. Various embodiments include electrical sheets, laminated cores, machine components, and/or methods. For example, some embodiments include an electrical sheet for an electric machine, characterized by two plates (1, 2) made of a ferromagnetic material, which are arranged parallel to one another and at a distance (5) from one another, wherein the plates (1, 2) are connected to one another at respective edges circumferentially in a fluid-tight manner; and a fluid (4) in an interior between the two plates (1, 2) formed by the distance.

In some embodiments, a pressure in the interior is lower than an ambient pressure of the electrical sheet.

In some embodiments, there are one or more support structures (6) in the interior, which support the plates (1, 2) in order to guarantee the distance (5).

In some embodiments, the interior is embodied in such a way that the fluid (4), when it is in a gaseous state, can flow from a first area (7) of the interior to a second area (8) of the interior.

In some embodiments, the interior is embodied in such a way that the fluid (4), when it is in a liquid state, can flow from the second area (8) to the first area (7).

In some embodiments, there is a capillary system in the interior, which is arranged between the first area (7) and the second area (8).

In some embodiments, the plates (1, 2) are embodied in an annular shape and have slots (9) for accommodating conductor coils of the electric machine.

As another example, some embodiments include a laminated core for an electric machine, which includes electrical sheets stacked on one another, wherein at least one of the electrical sheets is embodied as described herein.

As another example, some embodiments include a machine component for an electric machine, the machine component having an electrical sheet as described herein; and a cooling element (10), which is connected to the electrical sheet, so that an exchange of heat can take place between the electrical sheet and the cooling element.

As another example, some embodiments include a method for producing an electrical sheet for an electric machine, characterized by the following steps: additive manufacturing of a first plate (1) from a ferromagnetic material; additive manufacturing of an edge structure (3) connected in a fluid-tight manner to the first plate (1) along an edge of the first plate; additive manufacturing of a second plate (2) from a ferromagnetic material, which is connected to the edge structure (3) along an edge of the second plate in a fluid-tight manner; and introduction of a fluid (3) into an interior between the two plates (1, 2).

In some embodiments, support structures (6) between the first plate (1) and the second plate (2) are additively manufactured in order to guarantee a distance (5) between the plates (1, 2).

In some embodiments, the support structures (6) and the edge structure (3) are manufactured by means of a screen printing method using a common mask or by means of a stencil printing method using a common stencil.

In some embodiments, the plates (1, 2) are manufactured by means of a screen printing method or stencil printing method.

In some embodiments, after the manufacturing of the second plate (2) an opening is created in one of the plates (1, 2) or in the edge structure (3); the interior is evacuated via the opening; the fluid (4) is introduced through the opening into the interior after the evacuation; and the opening is sealed in a fluid-tight manner after the introduction of the fluid (4).

As another example, some embodiments include a computer program with commands that, when the computer program is executed by a computer system, cause an apparatus for additive manufacturing to carry out a method as described herein.

### BRIEF DESCRIPTION OF THE DRAWINGS

The teachings of the present disclosure are explained in greater detail below with the aid of concrete exemplary embodiments and associated schematic drawings. In the figures, elements that are the same or have the same functions are provided with the same reference characters. The description of the same or functionally identical elements is not necessarily repeated in different figures. In the drawings:

FIG. 1 shows a perspective diagram of an example of a form of embodiment of an electrical sheet incorporating teachings of the present disclosure;

FIG. 2 shows a schematic diagram of an example of a form of embodiment of a machine component incorporating teachings of the present disclosure;

FIG. 3 shows a cross-sectional diagram of the electrical sheet from FIG. 1; and

FIG. 4 shows an example of a work piece with support structures incorporating teachings of the present disclosure.

### DETAILED DESCRIPTION

In some embodiments, there is an interior space in a double-walled electrical sheet, which is filled with a fluid, in order to improve the thermal conductivity of the electrical sheet as a whole.

In some embodiments, an electrical sheet for an electric machine has two plates made of a ferromagnetic material, which are arranged parallel to one another and at a distance from one another. The plates in this case are connected circumferentially in a fluid-tight manner, in particular in a liquid- and gas-tight manner, to one another on respective edges of the plates.

A fluid is located between the two plates in an interior, in particular a hollow space, formed by the distance. By the circumferential connection of the plates at their edges, the distance between the plates at the edges is sealed in a completely fluid-tight manner. In particular the hollow space or interior is sealed off in a completely fluid-tight manner from an environment of the electrical sheet.

The connection of the plates to one another at their edges is in particular a material-to-material connection, for example one or more edge structures are located between the two plates at their edges, which each have a material-to-material connection to both the first and also to the second plate. The ferromagnetic material can for example include a steel, iron, an iron alloy, in particular an iron-silicon alloy, or another metal alloy suitable for electrical sheets.

In some embodiments, the two plates are essentially congruent or congruent such that their edges lie above one another or essentially lie above one another. The fluid can for example contain a liquid and/or a gas. For example, the fluid can contain water and/or water vapor.

With given conditions in the interior, in particular with a given internal pressure in the interior, the fluid, at a first temperature, which for example corresponds to a temperature of the heat source, for example of a winding of the electric machine, during the operation of the electric machine, is gaseous and at a second temperature, for example a temperature of a heat sink, such as a cooling element of the electric machine, is liquid.

Thus, the fluid, provided it is located in a first area of the interior that has an increased temperature, for example a first area in the vicinity of the heat source, can evaporate and in doing so take up energy from its environment in the form of heat. In the gas phase, in particular as vapor, the fluid can then for example flow into a second area of the electrical sheet, where it is cooled off, for example by a heat sink. Accordingly, the fluid can condense in the second area and give off the heat previously taken up again, for example to the heat sink. The condensed fluid can then for example flow or stream back into the first area.

The structure of the electrical sheet, in particular the interior with the fluid, enables a thermal conductivity of the electrical sheet as an overall system to be decisively improved. In some embodiments, the electrical sheet itself represents a heat pipe.

While typical materials that are employed for conventional electrical sheets, for example ferrous steels, have a relatively poor thermal conductivity, 20 to 80 W/(K*m) in the case of iron for example, it has been shown that, for an electrical sheet incorporating teachings of the present disclosure, values of above 1000 W/(K*m) can be achieved.

A markedly higher rate of heat exchange can therefore be achieved. The result of this is that the electrical power of the electric machine can be decisively increased without permitted limit values with regard to the development of heat in the machine possibly being exceeded. With the same power the electric machine can on the other hand be designed and built to be more compact, smaller, in particular shorter. This makes the machine lighter and savings can be made in production costs.

In some embodiments, the electrical sheet the plates have an annular shape, in particular basic shape.

In some embodiments, a pressure in the interior of the electrical sheet is lower than an ambient pressure, in particular ambient air pressure, of the electrical sheet. In other words a lower pressure, for example a vacuum, obtains in the interior of the electrical sheet. The value of the pressure in the interior is in particular tailored to a boiling point of the fluid and to the corresponding operating temperatures, i.e. the temperatures of the heat source and of the heat sink, during operation of the electric machine. The pressure in the interior is chosen in particular in such a way that the fluid is gaseous at a typical temperature of the heat source and liquid at a typical temperature of the heat sink.

In some embodiments, the pressure in the interior is less than or equal to 500 hPa, in particular less than or equal to 100 hPa, for example less than or equal to 50 hPa. In particular the pressure in the interior lies in a range of 10 to 100 hPa, in particular at 50 hPa or approximately 50 hPa. The lowering of the pressure in the interior by comparison with the ambient pressure, in particular by comparison with the normal air pressure, enables a lower boiling point of the fluid to be achieved, which makes possible an efficient cooling even with lower absolute temperatures of the heat source. A further advantage is that water can be employed as the fluid.

In some embodiments, the electrical sheet has one or more support structures, which support the plates in the interior in order to guarantee the distance. In particular the plates rest on the support structures, so that said plates are supported.

In some embodiments, the structures have a material-to-material connection with at least one of the plates, in particular with both plates.

In some embodiments, the support structures consist of the same material as the plates or feature this material. The support structures make it possible to select an especially low pressure in the interior of the electrical sheet, in particular without there being any danger of a deformation of the plates. A further advantage of the support structures is that an arrangement and/or a form or a surface structure of the support structures can support a transporting of the fluid, in particular a transporting of the fluid when it is in a liquid state. A surface, in particular a porous or rough surface, of the support structures in this case, as a result of cohesion forces, adhesion forces and/or capillary forces occurring, can effectively act as a capillary system or as a wick, which can transport the liquid fluid from the second area back to the first area.

Depending on arrangement and form of the support structures however, spaces between the structures can also be chosen small enough for said spaces to act as a capillary system. Through this a more efficient cooling or a more efficient dissipation of heat is possible, since the liquid fluid can be provided at the heat source more quickly and more reliably.

In some embodiments, the interior is embodied in such a way that the fluid, when it is in a gaseous state, can flow from a first area of the interior to a second area of the interior. The first area faces towards the heat source, for example windings of the electric machine. For example, an outer wall of the electrical sheet, which corresponds to or is opposite to the first area interior, can be contact with the heat source.

The embodiment of the interior, in particular the form and arrangement of the support structures, in particular enables a channel or a number of channels or a network of channels to be defined, along which the gaseous, in particular evaporated, fluid can flow. After the fluid has taken up heat from the heat source by evaporation, it can be transported away especially well in such forms of embodiment and transported to the second area.

In some embodiments, the interior is at least partly hollow.

In some embodiments, the first and the second area are connected to one another by channels and/or hollow spaces. In particular, the support structures may be arranged in such a way that they do not completely block a flow path between the first area and the second area for the gaseous fluid.

In some embodiments, the interior is embodied in such a way that the fluid, when it is in a liquid state, can flow from the second area to the first area.

In some embodiments, the flow of the liquid fluid from the second to the first area is supported by a surface roughness in the interior, in particular a surface roughness of the plates in the interior and/or of the support structures and/or by a capillary system, in particular additional capillary systems.

In some embodiments, the electrical sheet contains a capillary system in the interior, which is arranged between the first und the second area. The term capillary system in this case is to be understood in such a way that it has structures or elements, with regard to which the fluid in its liquid state shows a capillary effect. In particular, the term capillary system is not necessarily to be understood as a system of small tubes or the like.

The capillary system enables the flowing of the fluid in its liquid state from the second area to the first area to be supported. Through this more fluid for taking up heat is available or is available more quickly in the first area, which makes possible a more efficient or more effective cooling.

In some embodiments, the capillary system includes a metal mesh or a porous material with which the interior is filled.

In some embodiments, of the electrical sheet the fluid includes water or consists of water. The use of water is advantageous due to the availability, the low costs and the safe nature of water. Moreover, an advantageous pressure in the interior is readily technically achievable in the case of water.

In some embodiments, the plates are embodied in an annular shape and have slots to accommodate conductor coils of the electric machine. Annular in shape is not necessarily to be understood here in the mathematically exact sense, in particular not necessarily as exactly circular in shape. Annular can for example be understood in such a way that the plates have two concentric edges, in particular an inner edge and an outer edge and are embodied axially symmetrically or rotationally symmetrically for example. The plates can have a circular inner or outer edge for example.

The slots to accommodate the conductor coils can be formed on the inside or outside of the plates, in particular on inner edges or on outer edges of the plates, for example. Inside and outside can be understood here as a radial specification, not with regard to the interior of the electrical sheet. The first area of the interior corresponds to an area of the electrical sheet on which the slots are formed for example.

An electrical sheet embodied in this way can be used for example for a laminated core of a stator or rotor of an electric machine.

In some embodiments, an outer surface of the electrical sheet is coated with an electrically insulating material, in particular is completely coated with it. The electrically insulating coating, in stacked sheets or laminated cores, enables eddy currents to be avoided or reduced.

In some embodiments, a laminated core for an electric machine includes electrical sheets stacked on one another. At least one of the electrical sheets is embodied in accordance with the improved concept. The laminated core can for example have a stack consisting of a plurality, in particular between several tens and hundreds of thousands, of electrical sheets. In this case each of the electrical sheets can be embodied in accordance with the improved concept. In some embodiments, a specific proportion of the electrical sheets is embodied in accordance with the improved concept. Those electrical sheets that are embodied in accordance with the improved concept can be arranged regularly spaced within the stack of sheets for example.

In some embodiments, a machine component is a stator apparatus or rotor apparatus for an electric machine. The machine component has an electrical sheet, in particular a laminated core. The machine component moreover has a cooling element, which is connected to the electrical sheet so that an exchange of heat can take place between the electrical sheet and the cooling element.

The cooling element can be embodied as a cooling jacket for example, which surrounds the stack of sheets, for example on a radial outer side of the electrical sheets. The cooling element, in particular the cooling jacket, can be designed for fluid cooling or water cooling for example.

In some embodiments, an electric machine, in particular a generator or a motor, has a machine component incorporating teachings of the present disclosure.

In some embodiments, a method for producing an electrical sheet for an electric machine includes a first plate made of a ferromagnetic material is additively manufactured, i.e. by employing one or more steps for additive manufacturing or a method for additive manufacturing. Thereafter a fluid-tight edge structure connected to the first plate is additively manufactured along an edge of the first plate. Thereafter a second plate made of a ferromagnetic material, in particular the same ferromagnetic material as the first plate, is additively manufactured, wherein the additive manufacturing is undertaken in such a way that the second plate is connected with its edge structure fluid-tight along an edge of the second plate. In accordance with the method a fluid is introduced into an interior between the two plates.

The manufacturing of the plates and the edge structure is undertaken for example in such a way that there is a distance between the two plates. The distance is defined for example by a height of the edge structure. The edge structure can be embodied, depending on the form of the plates and their edges for example, as one contiguous edge structure or include two or more spatially separated structures.

By using the additive manufacturing method steps, it is possible to produce the electrical sheet efficiently and at low cost. Moreover, the additive manufacturing allows plates to be produced with a thickness that is smaller by an order of magnitude than a thickness or a minimal thickness of rolled sheets. For example, the thickness of the plates can be in the range of between 50 μm und 200 μm, in particular between 100 μm and 150 μm. As a rule no thickness of less than 0.3 mm can be achieved by means of rolling methods.

The fact that both the edge structure and also the plates are additively manufactured means that advantageously no further connection steps, i.e., steps going beyond the steps for additive manufacturing, are necessary in order to connect the two plates to one another.

In some embodiments, support structures between the first and the second plate are additively manufactured in order to guarantee a distance between the plates. The support structures can for example be manufactured together with the edge structure, in particular during common manufacturing steps.

In some embodiments, the support structures, and also the edge structures and the sheets, can therefore be produced additively and without additional connection steps.

In some embodiments, the support structures and the edge structure are manufactured by means of a screen-printing method or a stencil-printing method using a common mask or a common stencil or a common screen. The screen-printing or stencil-printing method in particular involve a screen-printing or stencil-printing method for three-dimensional additive manufacturing.

Production by means of a screen-printing or stencil-printing method is particularly well suited to production of objects with enclosed hollow spaces, such as for example an electrical sheet in accordance with the improved concept. Such embodiments of the method allow an especially efficient, rapid and low-cost manufacturing of the electrical sheet, since the connection of the plates and the creation of the support structures can occur in common steps.

In some embodiments, in particular before manufacturing of the second plate, capillary structures are inserted, which serve to support a transporting of the fluid. The capillary structures, which form a capillary system, can for example be filled in or likewise additively manufactured, for example together with the support structures and/or the edge structure.

In some embodiments, the plates are manufactured by means of a screen-printing or a stencil-printing method, wherein in particular a common further mask or further stencil is used for both plates. Therefore, in accordance with various forms of embodiment, only two stencils, screens or masks are required in order to produce the electrical sheet, namely a mask for the manufacturing of the edge structure and optionally the support structures and/or capillary structures, and a further mask for manufacturing the plates.

In some embodiments, after the manufacturing of the second plate, the method includes a step for heat treatment, in particular a sintering step. The step for heat treatment can serve in particular to increase the strength or hardness of the different components of the electrical sheet. Moreover, through the sintering or the heat treatment, a binder, which has been employed for example in the method for additive manufacturing, can be driven out or removed.

In some embodiments, after the manufacturing of the second plate, an opening is created, for example drilled, in an outer wall of the electrical sheet, in particular in one of the plates or the edge structure. The interior is evacuated via the opening and after the evacuation the fluid is introduced into the interior through the opening. After the introduction of the fluid the opening is sealed fluid-tight. The evacuation is to be understood for example as creation of a pressure in the interior that is lower than the ambient pressure of the electrical sheet.

Further forms of embodiment of the method for production of the electrical sheet in accordance with the improved concept emerge directly from the different embodiments of the electrical sheet, of the laminated core or of the machine component in accordance with the improved concept and vice versa in each case.

In some embodiments, a computer program includes commands that, when the computer program is executed by a computer system, cause an apparatus for additive manufacturing to carry out a method in accordance with the improved concept. The apparatus in this case can be a known apparatus for three-dimensional additive manufacturing, in particular for carrying out three-dimensional screen- or stencil-printing methods. The apparatus can include the computer system for example.

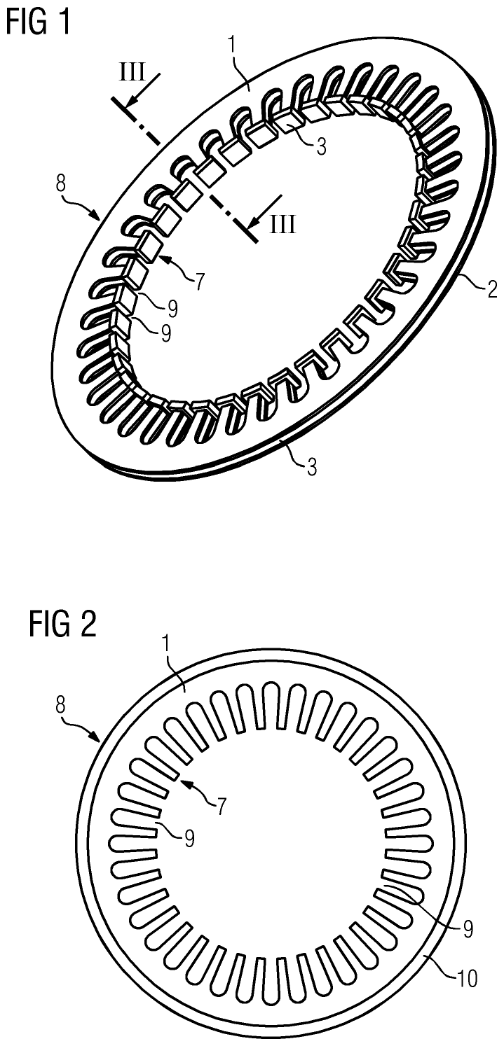

Shown in FIG. 1 is an example of a form of embodiment of an electrical sheet incorporating teachings of the present disclosure. The electrical sheet has a first plate 1, which is embodied in an annular shape and on an inner side has slots 9 for accommodating conductor coils of the electric machine. The electrical sheet moreover has a second plate 2, which is embodied and arranged congruent to the first plate and is arranged at a distance 5, in particular axial distance, from the first plate 1.

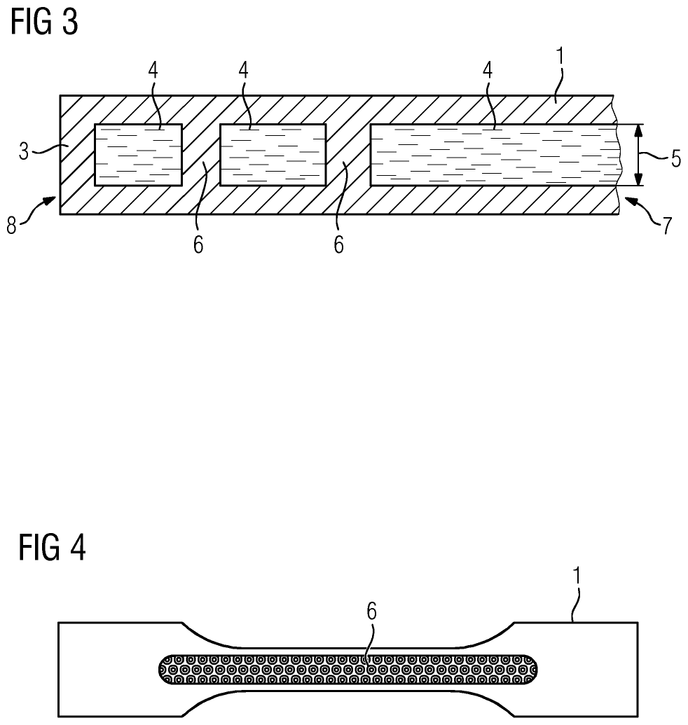

Shown in FIG. 3 is a corresponding cross-section of the electrical sheet, wherein a section axis is indicated in FIG. 1 by a dotted and dashed line. The electrical sheet moreover has edge structures 3, which connect the plates 1, 2 to one another at respective inner edges and outer edges of the plates circumferentially and completely, in particular a fluid-tight manner.

An area in which the slots 9 are located, e.g. an inner area 7, of the electrical sheet corresponds to an area at which the electrical sheet can be connected to a heat source, namely the electrical conductor coils heated up during operation of the electric machine. An outer area 8 of the electrical sheet, when the electrical sheet is built into the electric machine, can be in contact with a heat sink, for example a cooling element.

FIG. 2 shows a machine component, in particular a stator, of an electric machine, which contains an electrical sheet as shown in FIG. 1. Furthermore, the machine component contains a cooling element, in particular a cooling jacket 10, which in particular surrounds the outer area 8 of the electrical sheet. The cooling jacket 10 can be water-cooled for example, in order to accept heat from the electrical sheet and transport it away.

Located in an interior of the electrical sheet, which is defined by the two plates 1, 2 arranged spaced apart at a distance 5 from one another, is a fluid 4, in particular water or water vapor.

As shown in FIG. 3, the electrical sheet can optionally have support structures 6, which are arranged between the first plate 1 and the second plate 2 and support said plates, in particular guarantee the distance 5. This is in particular advantageous when a vacuum with regard to the ambient pressure of the electrical sheet obtains in the interior of the electrical sheet.

For further illustration a work piece is shown in FIG. 4, which likewise has a plate 1, which is opened for the purpose of illustration so that support structures 6 are visible, such as for example can also be employed in an electrical sheet in accordance with FIGS. 1 and 3.

The support structures 6 can in particular involve an arrangement, for example regular arrangement, of bar-shaped, square-shaped, tube-shaped or prism-shaped structures, which are arranged between the plates 1, 2 and for example are connected to said plates by a material-to-material connection and in a fluid-tight manner.

In the example of FIG. 1 to 3 shown, the fluid 4 can involve water or water vapor for example. The interior of the electrical sheet can for example be evacuated to a pressure of around 50 hPa or another pressure, for example in the range of between 10 and 100 hPa.

During the operation of the electric machine heat occurs, in particular caused by the conductor coils, which has to be transported away in order to prevent the electric machine overheating. The electrical sheet acts for example in a similar way to a heat pipe.

In the interior 7 of the electrical sheet, the fluid 4 is likewise heated up by the heated-up conductor coils, is evaporated and thereby takes up energy in the form of heat. In the gaseous state the fluid 4 can flow to the outer side or to the outer area 8 of the electrical sheet for example, where it is cooled for example by the cooling jacket 10, so that it condenses and accordingly gives off energy in the form of heat to the water or the cooling jacket 10. The condensed fluid 4 can, in particular supported by capillary effects, which are attributable to a roughness, for example a surface roughness of the support structures 6 and/or a roughness of the plates 1, 2, then flow back to the interior 7, where it can take up heat once again. As an alternative or in addition the return flow of the fluid 4 from the outer area 8 to the inner area 7 can be supported by a capillary system (not shown), which can be located in the interior of the electrical sheet.

An electrical sheet incorporating teachings of the present disclosure may include a floor, a roof, and an inner hollow structure. The hollow structure may include a gas-tight and fluid-tight hollow space, which in various forms of structures for supporting the transport of gas at a heat source to a heat sink and/or a capillary fluid transport from the heat sink to the heat source support. The structures or further structures can moreover serve as support structures, which stabilize the hollow space with regard to external forces.

The thermal conductivity of the electrical sheet is therefore increased from a relatively low value of the ferromagnetic material to a very high thermal conductivity of above 1000 W/(K*m) by the improved concept. Moreover, a low-cost and efficient way for producing the electrical sheet is specified by the additive manufacturing method. Fluid cooling directly in the conductors of the conductor coils, which is expensive and complex and possibly unsuitable for small electric machines, or additional cooling of the slots, can be dispensed with. Compromises in the filling of the copper slots may also possibly not be necessary.

What is claimed is:

1. An electrical sheet for an electric machine, the electrical, sheet comprises:
two plates of a ferromagnetic material, the two plates arranged parallel to one another at a distance from one another forming an interior between the two;
wherein the two plates are connected to one another at respective edges circumferentially in a fluid-tight manner; and
a fluid in the interior.

2. The electrical sheet as claimed in claim 1, wherein a pressure in the interior is lower than an ambient pressure of the electrical sheet.

3. The electrical sheet as claimed in claim 1, further comprising one or more support structures in the interior, the support structures supporting the plates at the distance.

4. The electrical sheet as claimed in claim 1, wherein the interior includes a first area and a second area so the fluid can flow from the first area to the second area.

5. (canceled)

6. The electrical sheet as claimed in claim 4, further comprising a capillary system in the interior arranged between the first area and the second area.

7. The electrical sheet as claimed in claim 1, wherein the two plates have in an annular shape and slots for accommodating conductor coils of the electric machine.

8. A laminated core for an electric machine, the core comprising:
electrical sheets stacked on one another;
wherein at least one of the electrical sheets comprises:
two plates of a ferromagnetic material, the two plates arranged parallel to one another at a distance from one another forming an interior between the two;
wherein the two plates are connected to one another at respective edges circumferentially in a fluid-tight manner; and
a fluid in the interior.

9. A machine component for an electric machine, the machine component comprising:
an electrical sheet comprising:
two plates of a ferromagnetic material, the two plates arranged parallel to one another at a distance from one another forming an interior between the two;
wherein the two plates are connected to one another at respective edges circumferentially in a fluid-tight manner; and
a fluid in the interior;
a cooling element connected to the electrical sheet to exchange of heat between the electrical sheet and the cooling element.

10. A method for producing an electrical sheet for an electric machine, the method comprising:
additive manufacturing of a first plate from a ferromagnetic material;
additive manufacturing of an edge structure connected in a fluid-tight manner to the first plate along an edge of the first plate;
additive manufacturing of a second plate from a ferromagnetic material, which is connected to the edge structure along an edge of the second plate in a fluid-tight manner; and
introducing of a fluid into an interior between the two plates.

11. The method as claimed in claim 10, further comprising adding support structures between the first plate and the second plate to guarantee a distance between the plates.

12. The method as claimed in claim 11, wherein the support structures and the edge structure are manufactured by means of a screen printing method using a common mask or by means of a stencil printing method using a common stencil.

13. The method as claimed in claim 10, wherein the plates are manufactured by means of a screen printing method or stencil printing method.

14. The method as claimed in claim 10, further comprising, after the manufacturing of the second plate:
creating an opening in one of the two plates or in the edge structure;
evacuating the interior via the opening;
introducing the fluid through the opening into the interior after the evacuation; and
sealing the opening in a fluid-tight manner after the introduction of the fluid.

15. (canceled)
